(19) United States
(12) Patent Application Publication
(10) Pub. No.: US 2009/0016850 A1
(43) Pub. Date: Jan. 15, 2009

(54) Bookbinding Unit and Image-Forming System

(75) Inventors: Hiroyuki Sorita, Chuo-shi (JP); Takehiro Yamakawa, Minamitsuru-gun (JP); Jun Kondou, Minami-Alps-shi (JP); Katsumasa Takagi, Kofu-shi (JP); Takeshi Harada, Nakakoma-gun (JP)

Correspondence Address: Judge Patent Associates, Dojima Building, 5th Floor, 6-8 Nishitemma 2-Chome, Kita-ku, Osaka-Shi, 530-0047, JP

(73) Assignee: NISCA CORPORATION, Yamanashi-ken (JP)

(21) Appl. No.: 12/171,334

(22) Filed: Jul. 11, 2008

(30) Foreign Application Priority Data
Jul. 11, 2007 (JP) 2007-182603

(51) Int. Cl. B42C 9/00

(52) U.S. Cl. 412/37

(57) ABSTRACT

Bookbinding unit that, in feeding cover sheets to a predetermined cover-fitting position, is able to feed various sheets/leaves, yet without defacing of or scratch marks in the cover sheets, nor press marks during cover formation, occurring. Provided are an incoming sheet conveyance path for sequentially bringing in printed sheets; a stacking tray unit for stacking and collating into bundles sheets from the conveyance path; a bookbinding process path that transports sheet bundles from the stacking tray unit to a predetermined cover-binding position; and a cover feed path for feeding cover sheets to the cover-binding position. A protective-sheet storage tray for supplying jacketing sheets is annexed to the cover feed path, and a conveyance unit that overlays fed cover sheets with jacketing sheets from their storage tray and transports the jacketed cover sheets to the cover-sheet binding position is disposed in the cover feed path.

### BACKGROUND OF THE INVENTION

1. Technical Field

The present invention-involving bookbinding units that collate into bundles sheets conveyed out from photocopiers, printers, and the like, and finish the bundles into cover-sheet bound booklets-relates to improvements in cover-sheet feeding mechanisms for the encasing of inner-bound sheet bundles in cover sheets.

2. Description of the Related Art

Generally, this kind of bookbinding unit collates into sheet bundles on a stacking tray sheets conveyed out from an image-forming unit, and applies adhesive to a spine portion of the sheet bundle. Meanwhile, a cover sheet is fed from an inserter (a feeding apparatus) disposed upstream of the image-forming unit or stacking tray to a cover-sheet binding position provided downstream of the adhesive application position. Then the sheet bundle coated with adhesive at the cover-sheet binding position is joined to the central portion of the cover sheet in an upside-down T-configuration, and the cover sheet is folded to form shoulders on the sheet bundle (to form the booklet). These processes are known in the art.

This type of system is disclosed in Japanese Unexamined Pat. Pub. App. No. 2005-305822 (cf. FIG. 1). In the disclosure, a stacking tray is linked to a sheet discharge outlet of an image-forming unit. The printed sheets are stacked on that tray. After the spine portion of sheets collated into a bundle is coated with adhesive, the sheet bundle is conveyed to a downstream binding position. A cover-sheet supply path that branches from an incoming sheet conveyance path to convey sheets to the stacking tray is provided in the cover-sheet binding position; cover sheets are conveyed from the cover sheet supply path and set into the cover-sheet binding position.

Although it is not disclosed in the publication mentioned above, a system configuration is already known wherein an inserter unit (a feeding apparatus) is disposed between the image-forming unit and the cover-sheet binding position (stage) to selectively convey cover sheets from the inserter unit and the image-forming unit.

When a cover sheet is automatically conveyed to the cover-sheet binding position (the bookbinding stage) as described above, conventionally, the cover sheet is fed either from a stacker in the image-forming unit connected to the bookbinding unit or it is fed from a stacker in the inserter unit connected to the bookbinding unit. In such a case, the cover sheet is either fed from the stacker via the image-forming unit, or from a stacker disposed outside of the bookbinding unit to the bookbinding position via inside the bookbinding unit. Therefore, the bookbinding unit is provided sheet guides and a conveyance roller that convey the cover sheet from the stacking position to a predetermined binding position.

Various types of paper are used as cover sheets in a bookbinding unit. For example, special sheets such as glossy paper, one surface of which is coated with a varnish, cover-sheet paper covered with fabric, or windowed sheets with an opening to expose a title have been used. There is a problem with those kinds of special sheets in that the conveyance mechanisms, such as rollers, belts, and sheet guides, peel away the cover sheet coating layer. Therefore, special sheets cannot be used as cover sheets in a conventional apparatus configuration.

In other words, when using special paper like the ones described above as cover sheets, friction marks, abrasions, and other kinds of defacement caused by the conveyance rollers occur on surfaces of coated sheets or fabric-covered sheets. There is also the problem of an edge of a windowed sheet becoming jammed on the paper guides and the like.

Furthermore, after the cover sheet is conveyed to the cover-sheet binding position, the cover sheet is folded over the spine of the inner-bound leaf bundle by pressing members. The cover sheet at this time is folded by pressing members. When the cover sheet is sandwiched between the pressing members, these members can leave pressing marks on the cover sheet surface, thereby creating the problem of a poor esthetic appearance of the finished book.

### BRIEF SUMMARY OF THE INVENTION

Therein, the inventors arrived at the concept of, when conveying special cover sheets from a stacker to a predetermined binding position, preventing friction marks, abrasions and paper jams by overlaying a for-conveyance protective sheet onto the cover sheets and conveying them.

A main object of the present invention is to provide a bookbinding unit that feeds various types of sheets when feeding a cover sheet from a stacker to predetermined cover binding position, and does not deface, cause friction marks or pressing marks on the cover sheet surface when forming the cover.

The present invention employs the following configuration to solve the problems discussed above. A bookbinding unit according to the present invention is equipped with stacking tray means for stacking into bundles, and supporting, sheets on which images have been formed; a bookbinding path for guiding the sheet bundle from the stacking tray means to a predetermined cover-sheet binding position; a cover feed path for feeding a cover sheet to the cover-sheet binding position; and protective-sheet storage tray that supplies a jacketing sheet to the cover feed path. Further, a conveyance means that overlays fed cover sheets with jacketing sheets supplied from the protective-sheet storage tray and that transports these the jacketed cover sheets to the cover-sheet binding position is disposed in the cover feed path.

The protective-sheet storage tray is disposed in a feeder unit that feeds the cover sheet to the cover feed path, and is configured to selectively supply cover sheets to the cover feed path from either the feeder unit or from the image-forming unit.

The protective-sheet storage tray is disposed in the feeder unit that feeds cover sheets to the incoming sheet conveyance path. This feeder unit also has a first tray member that stores the cover sheets, and a second tray member that stores jacketing sheets.

The conveyance means disposed in the incoming sheet conveyance path or the cover feed path has a registration means that momentarily pauses a jacketing sheet from the protective-sheet storage tray and overlays it with a cover sheet conveyed from the incoming sheet conveyance path. The registration means is configured to underlay the jacketing sheet along the spine-cover side of the cover sheet.

Cutting means is disposed downstream of the cover sheet binding means in the bookbinding path. The cutting means is configured to trim true and align the edges of the covered sheet bundle. The cutting means cuts the jacketing sheets at the same time as trimming the edges of the sheet bundle for alignment. Also, stacking means for storing the bound sheets is provided at a downstream side of the cutting means. The stacking means is configured to store sheet bundles and jacketing sheets that have been trimmed true and aligned by the cutting means.

An image forming system according to the present invention is composed of an image-forming unit that sequentially forms predetermined images on sheets, and a bookbinding unit connected to a discharge outlet of the image-forming unit, that collates sheets having printed images into a stack or sheet bundle and binds that sheet bundle to a cover sheet. The bookbinding unit is configured as described above.

The present invention provides a protective-sheet storage tray that stores jacketing sheets in the cover feed path of the bookbinding unit. When conveying a cover sheet to the predetermined binding position, the cover sheet is overlaid with a jacketing sheet during conveyance, which has the following effects.

The cover sheet is covered by a jacketing sheet when being conveyed through the cover feed path so no markings from abrasion or friction caused by conveyance roller and the like remain on the cover sheet. The cover sheet is also not defaced by rollers and the like. Cover sheets with an opening for a title and the like do not get jammed by the roller or paper guides and the like. In such a case, it is possible to solve the problem of degraded appearance of the cover sheet after the bookbinding process by overlaying a jacketing sheet over the cover sheet.

Also, the present invention provides a feeder unit in the bookbinding unit. A cover sheet storage tray and a jacketing sheet storage tray are attached to this unit. Because it is configured to overlay a jacketing sheet over a cover sheet when the cover sheet is being fed to the cover-sheet binding position, the structure is simple and low-cost, and can solve the problems of defacing or damaging sheets, and paper jams.

### BRIEF DESCRIPTION OF THE SEVERAL VIEWS OF THE DRAWINGS

FIG. 1 is an overall view of an image-forming system equipped with a bookbinding unit of the present invention;

FIG. 2 is a detailed explanatory view of the bookbinding unit in the system shown in FIG. 1;

FIGS. 3A and 3B show a configuration of an adhesive applicator means in the unit shown in FIG. 2; FIG. 3A is block diagram of an adhesive container; FIG. 3B is an explanatory view of an aspect of an adhesive applicator;

FIG. 4 is an explanatory view of a configuration of a cover sheet binding means, sheet-bundle attitude biasing means, and cutting means in the unit shown in FIG. 2;

FIG. 5 is an expanded view of the essential portion of FIG. 2, showing a cover feed path;

FIGS. 6A and 6B are explanatory views of a cover sheet conveyance state in the unit shown in FIG. 2; FIG. 6A shows a cover sheet being conveyed from an inserter unit; FIG. 6B shows the cover sheet being conveyed from the image-forming unit; and

FIG. 7 is a block diagram of a configuration of control means in the system shown in FIG. 2.

### DETAILED DESCRIPTION OF THE INVENTION

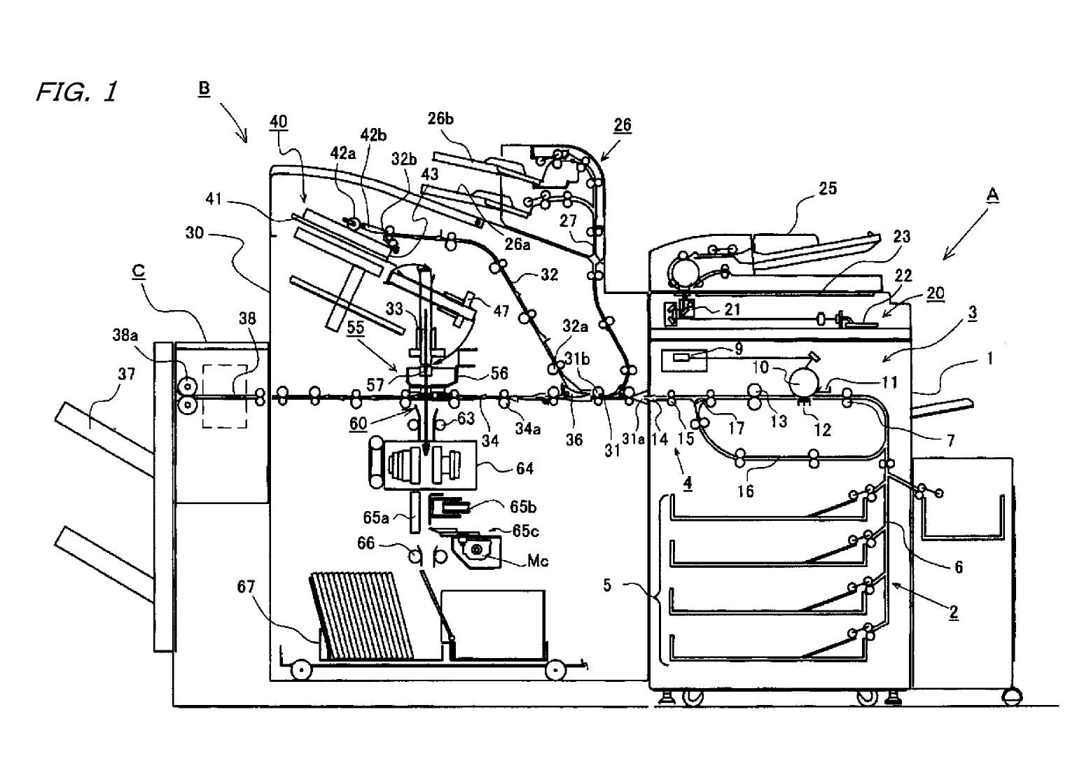

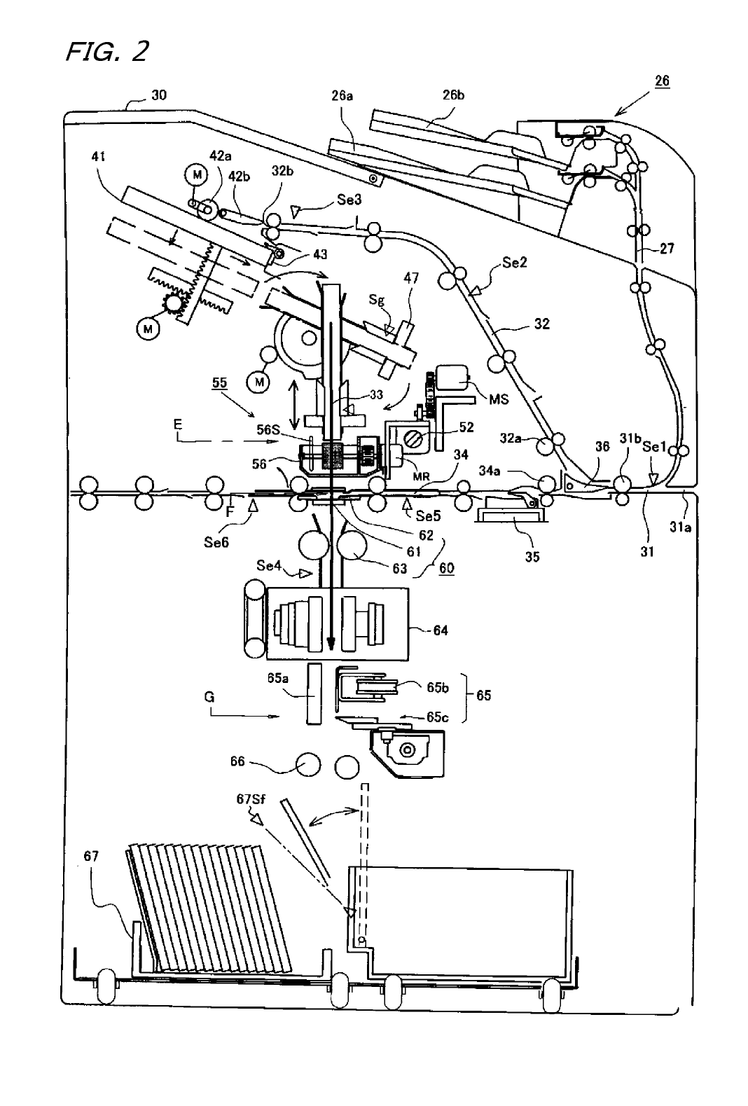

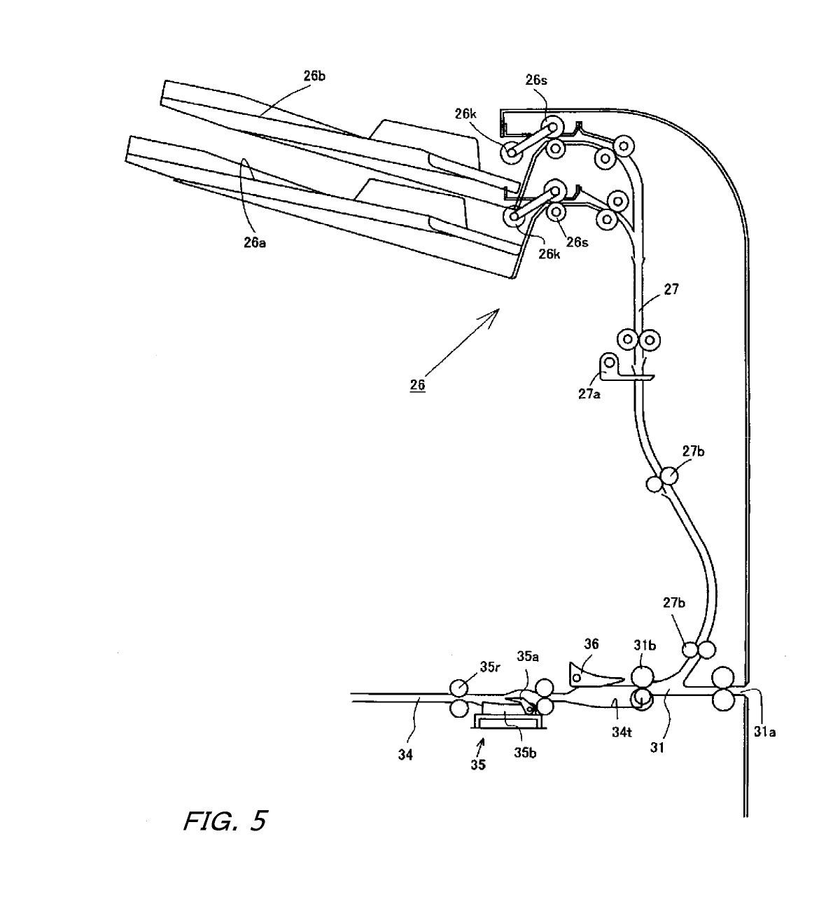

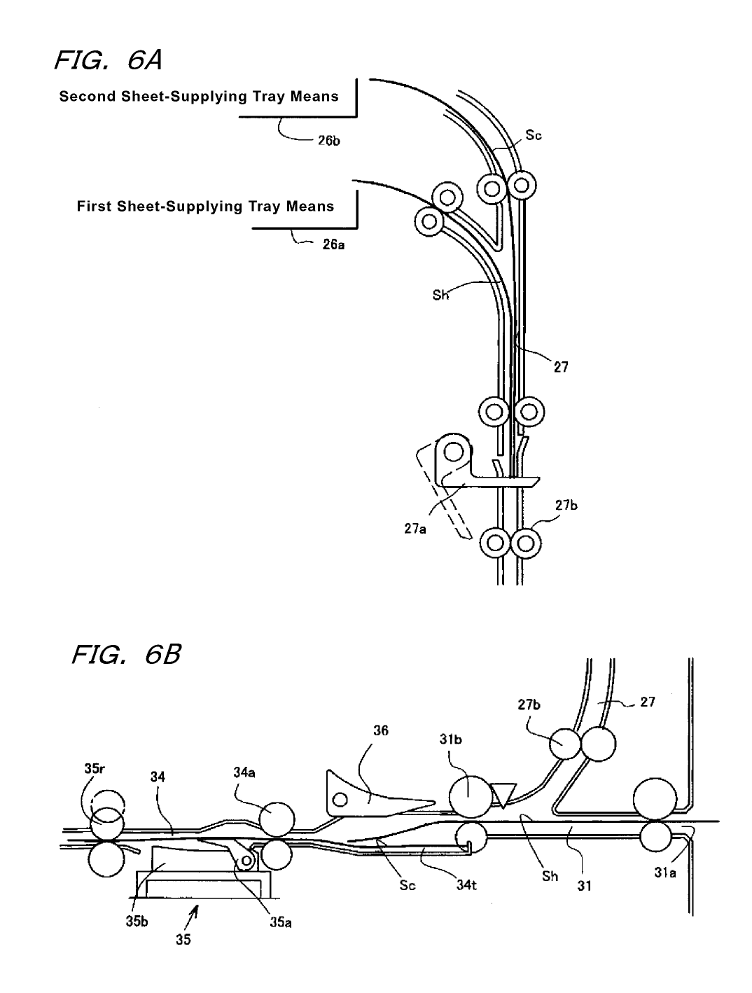

A preferred embodiment of the present invention will now be explained with reference to the drawings provided. FIG. 1 is an explanatory view of a bookbinding unit according to the present invention, and an overall configuration of an image-forming system using the bookbinding unit; FIG. 2 is a detailed explanatory view of the bookbinding unit. FIG. 5 is an expanded view of the essential portion of FIG. 2, showing a cover feed path. FIG. 6 is an explanatory view of the conveyance of the cover sheet.

As shown in FIG. 1, the image-forming system of the present invention is composed of an image-forming unit A that sequentially forms images on sheets, and a bookbinding unit B connected to a discharge outlet 14 of the image-forming unit A, that collates into sheet bundles sheets formed with images, binds the sheet bundle to form a booklet and trims the booklet. Also, a first sheet-supplying tray means 26a that stores cover sheets, and a second sheet-supplying tray means 26b that stores jacketing sheets are provided in the bookbinding unit B. Also, a finishing unit C is disposed downstream of the bookbinding unit B in the apparatus of FIG. 1. The following will now describe the configuration of each unit in detail.

### Cover Sheet Feeding Method

First, the feeding method of the present invention will be explained with reference to the schematic drawings of FIGS. 5 and 6A and 6B. The bookbinding unit B according to the present invention has a conveyance path 31 that sequentially conveys sheets out of the image-forming unit A. As described below, the bookbinding unit B is configured to feed a sheet from the conveyance path 31 to the stacking tray means (stacking tray 41) that collates the inner leaves of the sheet bundle Sn and the cover-sheet binding position F that binds the cover sheet Sh. The system is configured to feed sheets from the conveyance path 31 to a stacking tray means (hereinafter referred to as stacking tray 41) that collates the inner leaves of the sheet bundle Sn as described below, and to convey the cover sheet Sh to the cover-sheet binding position F.

The present invention equips a protective-sheet storage tray (second feeding tray 26b) in the conveyance path (that configures a portion of the cover feed path) 31 described above. For that reason, the protective-sheet storage tray 26b and a feeding path 27 that conveys a jacketing sheet from that tray to the conveyance path 31 are connected to the conveyance path 31.

It is preferable that the protective-sheet storage tray 26b is installed in an inserter unit (paper feeding device) 26 that feeds cover sheets Sh to the conveyance path 31. In such a case, the inserter unit 26 can be configured to be built-in to the bookbinding unit B or to be a separate unit in a housing separate from the bookbinding unit. The device shown in the drawings is integrated to the inside of the bookbinding unit B, and the first sheet-supplying tray means 26a and second sheet-supplying tray means 26b that store cover sheets Sh are disposed with one above the other. In this way, the present invention selectively feeds a cover sheet Sh from the image-forming unit A or the inserter unit 26 to the cover-sheet binding position F (bookbinding stage) described below.

The present invention also overlayingly feeds the cover sheet Sh fed from the image-forming unit A or the inserter unit 26 and a jacketing sheet Sc from the protective-sheet storage tray 26b to the cover-sheet binding position F, and creates a booklet by overlaying both sheets simultaneously at that position. Overlaying the jacketing sheet Sc and cover sheet Sh will be explained for (1) feeding the cover sheet Sh from the inserter unit 26, and (2) feeding the cover sheet Sh from the image-forming unit A.

Feeding Cover Sheets Sh from Inserter Unit 26

As shown in FIG. 5, the inserter unit 26 is disposed in a position where it is linked to the conveyance path 31. The first sheet-supplying tray means 26a and the second sheet-supplying tray means 26b are arranged with one above the other in the inserter unit 26. A kick-roller 26k and separating means (a roller or belt or the like) 26s are disposed in each tray. Also, the feeding path 27 that is connected to the conveyance path 31 is equipped downstream of the separating means 26s. Aligning means 27a that overlays sheets from the first sheet-supplying tray means 26a and second sheet-supplying tray means 26b is equipped in the feeding path 27. This aligning means 27a is composed of a mechanism such as a gate stopper or pair of registration roller and the like, for example, to engage the leading edges of the cover sheet Sh and jacketing sheet Sc fed simultaneously to the feeding path 27 to overlay the sheets. Note that the present invention is configured to either have a plurality of sheets set in the second sheet-supplying tray means 26b that stores jacketing sheets and sends them separately as shown in the drawing, or to manually feed one cover sheet at a time in the tray (not shown).

FIG. 6A shows aligning means 27a composed of a gate stopper. This gate stopper 27a is composed, as described below, to be moved from the feeding path 27 to a retreated position (dashed lines in the drawing) by a solenoid, not shown. Two sheets the leading edges thereof stopped by the aligning means 27a are overlaid and fed to the conveyance path 31 by downstream conveyance roller 27b. The cover sheet Sh and jacketing sheet Sc fed to the conveyance path 31 using this configuration are fed to a predetermined cover-sheet binding position F from the cover feed path 34, described below.

Feeding Cover Sheets Sh from Image-Forming Unit A

As shown in FIG. 5, only the jacketing sheet Sc from the second sheet-supplying tray means 26b of the inserter unit 26 is fed to the feeding path 27, and from this path the jacketing sheet Sc is conveyed to the conveyance path 31. A buffer path 34t is provided in the conveyance path 31 to temporarily idle the jacketing sheet Sc. The drawing shows that the buffer path 34t is disposed downstream of the conveyance roller 31b disposed in the conveyance path 31. This buffer path 34t is disposed in the cover feed path 34 described below. An aligning mechanism 35 that aligns the cover sheet Sh and forward and reverse rotating roller 35r for aligning the sheets are disposed in this path. 35a in the drawing denotes a nipping claw for aligning; 35b denotes an aligning member that aligns sheets in a direction perpendicular to the conveyance direction. The jacketing sheet Sc fed from the conveyance path 31 to the forward and reverse rotating roller 35r is switched back by the forward and reverse rotating roller 35r. When this happens, the jacketing sheet Sc is idled at the buffer path 34t directly below the conveyance roller 31b.

In this state, as shown in FIG. 6B, the cover sheet Sh is fed from the image-forming unit A to the conveyance path 31. At this time, the conveyance roller 34a and the forward and reverse rotating roller 35r of the cover feed path 34 are configured to be retreated upward from the cover feed path. Therefore, the cover sheet Sh fed to the conveyance path 31 is conveyed over the jacketing sheet Sc temporarily idled in the buffer path 34t and both sheets are overlaid one over the other. Then, both sheets are aligned by the aligning mechanism 35 described below and fed to the downstream cover-sheet binding position F.

### Configuration of Image-Forming Unit

As shown in FIG. 1, the image-forming unit A can adopt a variety of structures of a copier, printer or printing machine. The drawing shows an electrostatic printing system. This image-forming unit A has a feeding unit 2, printing unit 3, discharge unit 3 and control unit in the casing 1. A plurality of cassettes 5 corresponding to sheet sizes is prepared at the feeding unit. Sheets of the size specified by the control unit are fed to the sheet feed path 6. A registration roller 7 is equipped at the sheet feed path 6. After the leading edge of the sheet is registered by this roller, it is fed at a predetermined timing to the downstream printing unit.

A static electric drum 10 is equipped at the printing unit 3. A print head 9, a developer 11 and a transfer charger 12 are disposed around this drum 10. The print head 9 is composed of a laser emitter, for example, to form electrostatic latent images on the electrostatic drum 10. Toner ink adheres to the latent image at the developer 11, and this is transferred and printed on the sheet at the transfer charger 12. The printed sheet is the fixed at the fixer 13 and discharged to the discharge path 17. A discharge outlet 14 formed in the casing 1 and a discharge roller 15 is disposed at the discharge unit 4. The symbol 16 in the drawing denotes a recirculation path. A printed sheet from the discharge path 17 is turned over from front to back at the switchback path and fed to the registration roller 7 to be formed with images on its backside. In this way, a sheet formed with images on one side or both sides is conveyed from the discharge outlet 14 by the discharge roller 15.

The symbol 20 in the drawing denotes a scanner unit. This optically reads original images to print using the print head 9. As is generally known in the art, the scanner is composed of a platen 23 where an original sheet is set; a carriage 21 that scans the original image along the platen 23; and an optical reading means (for example, a CCD device) that photo-electrically converts optical images received from the carriage 21. The drawing shows an original feeding apparatus 25 that automatically feeds the original sheet to the platen, installed over the platen 23.

### Configuration of Bookbinding Unit

Next, the bookbinding unit B connected to the image-forming unit A will now be explained with reference to FIG. 2. The bookbinding unit B is composed of a stacker 40 that stacks and aligns printed sheets into bundles; an adhesive applicator means 55 that applies adhesive to the sheet bundle conveyed from the stacker 40; and cover sheet binding means 60 that binds the cover sheet to the sheet bundle applied with adhesive, in the casing 30.

### Configurations of Conveyance Paths

A conveyance path 31 having a conveyance inlet 31a linked to the discharge outlet 14 of the image-forming unit A is provided in the casing 30, and the inner sheet conveyance path 32 and cover feed path 34 are linked from this conveyance path 31 via the path switching flapper 36. The bookbinding process path 33 is linked to the cover feed path 34 via the stacker 40, and a finishing path 38 is connected to the cover feed path 34. The bookbinding process path 33 is disposed to traverse the apparatus longitudinally in a substantially vertical direction, and the cover feed path 34 is disposed in a direction to traverse the apparatus in a horizontal direction.

The bookbinding process path 33 and the cover feed path 34 mutually intersect (orthogonally); the cover sheet binding means 60, described below, is disposed in the intersection. The conveyance path 31 configured as described above is linked to the discharge outlet 14 of the image-forming unit A to receive printed sheets from the image-forming unit A. Sheets Sn printed with content information (the inner leaves of sheets), and a sheet Sh printed with a title and the like to be used as a cover sheet (a cover sheet) are conveyed out from the image-forming unit A. This conveyance path 31 is branched into the inner sheet conveyance path 32 and the cover feed path 34, and sorts printed sheets to convey them into each path by the use of a path switching flapper 36.

On the other hand, the inserter unit 26 is connected to the conveyance path 31. This is configured to feed a cover sheet Sh not printed at the image-forming unit A one at a time from the first sheet-supplying tray means 26a to the conveyance path 31. The first sheet-supplying tray means 26a and second sheet-supplying tray means 26b are arranged with one above the other in this inserter unit 26 as described above. The first sheet-supplying tray means 26a stores the cover sheets Sh; the second sheet-supplying tray means 26b stores the jacketing sheets Sc. The kick-roller 26k and separating means 26s are provided in each tray; sheets are kicked out of the tray by the kick-roller 26k, and separated into single sheets by the separating roller 26s and conveyed downstream. Also, the feeding path 27 that is connected to the conveyance path 31 is equipped downstream of the separating means 26s. Aligning means 27a that overlays sheets from the first sheet-supplying tray means 26a and second sheet-supplying tray means 26b simultaneously or in tandem is equipped in the feeding path 27.

The conveyance roller 31b is disposed in the conveyance path 31; the conveyance roller 32b is disposed in the inner sheet conveyance path 32; the gripping conveyance means 47, the sheet-bundle attitude biasing means 64 described below, and discharge roller (discharge means) 66 are disposed in the bookbinding process path 33. The conveyance roller 34a is disposed in the cover feed path 34, the conveyance roller 38a is disposed in the finishing path 38, and each of these rollers is connected to a drive motor.

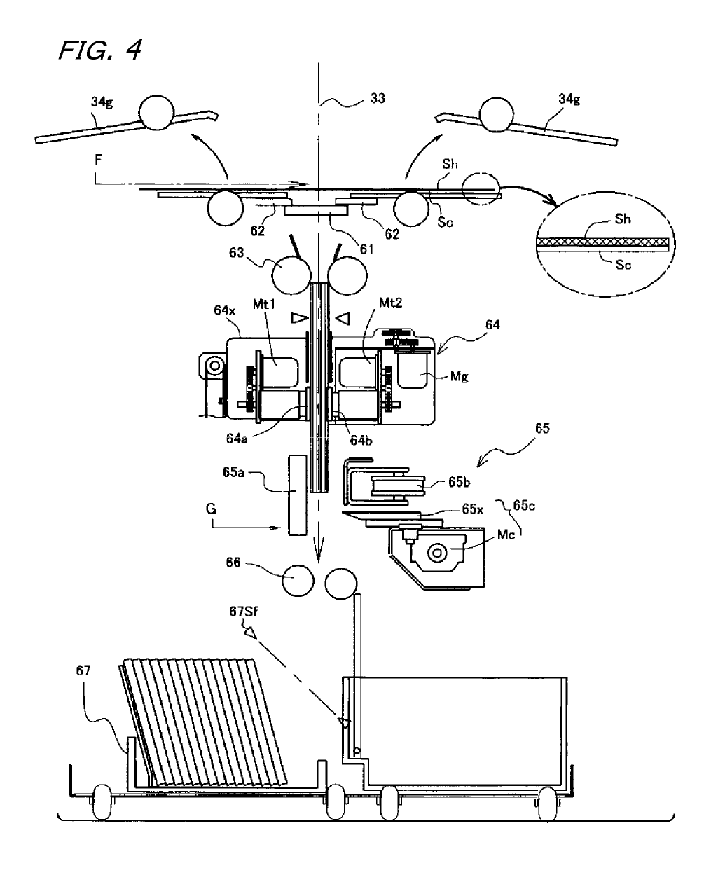

A configuration of the cover feed path 34 will now be explained with reference to FIGS. 4 and 5. This path is arranged to intersect the bookbinding process path 33 branching from the conveyance path 31; the cover-sheet binding position (bookbinding stage) F is disposed in this intersection. The conveyance roller 34a that convey the cover sheet Sh and the aligning mechanism 35 are disposed in the bookbinding process path 33. Also, the path guide that forms the cover feed path 34 is composed of a guide 34g that is movable in up and down directions between a guide posture and retreat posture upstream and downstream of the cover-sheet binding position F. This is so that it is positioned in the guide posture (see FIG. 2) when guiding the cover sheet Sh to the cover-sheet binding position F, and can shift to the retreated posture (see FIG. 4) when the cover sheet Sh is being folded.

The aligning mechanism 35 is composed of a nipping claw 35a disposed in the cover feed path 34 to engage a trailing end of the cover sheet Sh, an aligning member 35b that offsets the cover sheet Sh gripped by the nipping claw in a direction perpendicular to the direction of conveyance, and the forward and reverse rotating roller 35r that switches back the cover sheet Sh fed to the cover feed path 34 to touch the nipping claw 35a. The forward and reverse rotating roller 35r is configured to rise and lower to and from an idling position retreated above the cover sheet Sh.

The cover sheet Sh conveyed into the cover feed path 34 is switched back and conveyed by the reverse rotation of the forward and reverse rotating roller 35r after its trailing end passes the aligning means 27a. When doing so, the trailing end of the sheet is aligned to remove any skewing (traveling at an angle) of the sheet by abutting the nipping claw 35a. In this state, the nipping claw 35a grips the trailing end of the sheet and the aligning means 35b mounted with the nipping claw 35a moves in a direction perpendicular to the direction of conveyance to align the sides of the sheet. This corrects any skewing in the cover sheet Sh in the front and back directions, and corrects the position of the width direction of the sheet (side position correct). The cover sheet Sh having been aligned in this way is conveyed toward the downstream cover-sheet binding position F by the forward and reverse rotating roller 35r and set at that position. The cover sheet Sh is conveyed and set at the cover-sheet binding position F by being conveyed from the aligning position a predetermined conveying amount. Note that the present invention aligns and corrects skewing while the jacketing sheet Sc is overlaying the aligned cover sheet Sh.

### Configuration of Stacker

The stacking tray 44 arranged at the discharge outlet 32b of the inner sheet conveyance path 32 stacks and stores sheets from the discharge outlet 32b in a bundle. As shown in FIG. 2, the stacking tray 41 is composed of a tray member disposed substantially laterally, and is equipped thereabove with forward and reverse rotating roller 42a and conveyance guide 42b. Also, printed sheets from the conveyance outlet 32b are guided onto the stacking tray 41 by the conveyance guide 42b and stored by the forward and reverse rotating roller 42a. The forward and reverse rotating roller 42a moves the printed sheet to the leading edge of the stacking tray 41 with a forward rotation, and controls the trailing end of the sheet to abut an aligning member 43 provided at a trailing edge of the tray (see FIG. 2) with a reverse rotation. Sheet side aligning means, not shown, are provided in the stacking tray 41 to align the sides of the printed sheet in the tray using the both sides as a reference. The printed sheets from the inner sheet conveyance path 32 are sequentially lifted into the stacking tray 41 and collated to form a sheet bundle.

A sheet bundle thickness identifying means, not shown, is installed on the stacking tray 41 to detect the thickness of the sheet bundle stacked in the tray. With this configuration, a paper touching piece is installed to touch the top sheet on the tray. A sensor detects the position of the paper touching piece to identify the thickness of the sheet bundle. As another sheet bundle thickness identifying means, a discharge sensor Se3 detects sheets conveyed out to the stacking tray. A counter is provided to count the signals emitted from the sensor. It is possible to determine the thickness of the sheet bundle by multiplying the total number of sheets counted at the job end signal sent from the image-forming unit A by the average thickness of a single sheet.

### Configuration of Sheet-Bundle Conveyance Means

Gripping conveyance means 47 is disposed in the bookbinding process path 33 to move the sheets from the stacking tray 41 to the downstream adhesive application position E. This gripping conveyance means 47 changes the orientation of the sheet bundle stacked on the stacking tray 41 as shown in FIG. 2 from a horizontal posture to a vertical posture, and conveys the sheet bundle to the adhesive application position E along the bookbinding process path 33 disposed in a substantially vertical direction. For that reason, the stacking tray 41 moves to a handing-over position (dashed lines in FIG. 2) from the stacking position (solid lines in FIG. 2) to hand-over the sheet bundle to the gripping conveyance means 47 ready at the handing-over position.

### Configuration of Adhesive Application Unit

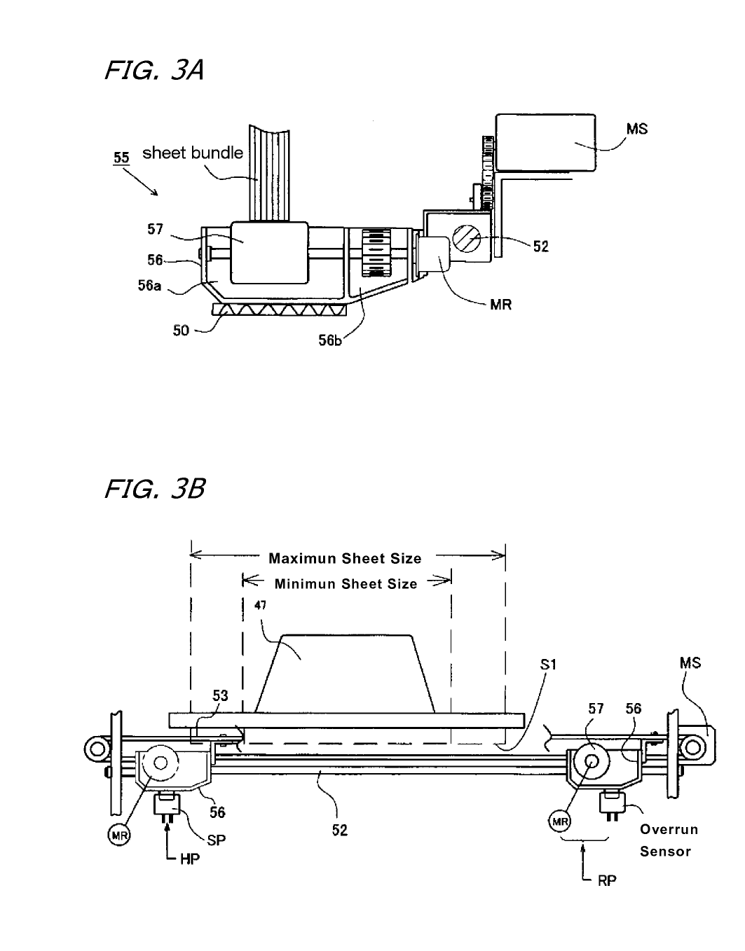

Adhesive application means 55 is provided in the adhesive application position E of the bookbinding process path 33. As shown in FIG. 3(a), the adhesive application means 55 is composed of an adhesive container 56 that stores hot-melt adhesive, an applicator roller 57 and a roller rotating motor MR. The adhesive container 56 is separated into a liquefied adhesive compartment (hereinafter referred to as the liquid adhesive compartment) 56a and a solid adhesive compartment 56b, and the applicator roller 57 is rotatably installed in the liquid adhesive compartment 56a. An adhesive sensor 56S (see FIG. 2) is installed in the liquid adhesive compartment 56a to detect the amount of adhesive remaining therein. The adhesive sensor 56S shown in the drawing also functions as an adhesive temperature sensor. In other words, it detects the temperature of the liquefied adhesive in the liquid adhesive compartment 56a and at the same time, it detects the amount of adhesive remaining according to the temperature difference of the portion immersed in the adhesive. Heating means 50 such as an electric heater and the like is embedded in the adhesive container 56. The adhesive sensor 56S and heating means 50 are connected to a control CPU 75 to adjust the temperature of the adhesive in the liquid adhesive compartment 56a to a predetermined melting temperature. The adhesive roller 57 is composed of a porous material that is heat-durable. It is configured to allow a layer of adhesive form around the circumference of the roller by being permeated with adhesive.

The adhesive container 56 configured this way is reciprocatingly driven along the spine of the sheet bundle. As shown in the conceptual drawing of FIG. 3(b), the adhesive container 56 is formed to be shorter (dimensions) than the bottom edges S1 of the sheet bundle S (the spine cover sheet portion when forming the booklet), and is supported on a guide rail 52 of the apparatus frame to move along with the adhesive roller 57 along the bottom edges S1 of the sheets. Also, the adhesive container 56 is connected to a timing belt 53 mounted to the apparatus frame, and a driver motor MS is connected to the timing belt 53.

The adhesive container 56 is reciprocated by the drive motor MS between a home position HP and a return position RP where it starts the operation to move along the sheet bundle. Each position is set to relationships shown in FIG. 3(b), and the return position RP is set according to the size information of the sheet width. When the power is turned on, this is set at the home position HP, and after a predetermined amount of time after a sheet grip signal is issued from a grip sensor Sg disposed on the gripping conveyance means 47 for example, this moves from the home position HP to the return position RP. At the same time as the movement, the roller rotating motor MR starts rotating the applicator roller 57. Note that SP denotes the home position sensor of the adhesive container 56. With the adhesive application means 55 configured as described above, the rotation of the drive motor MS starts moving the adhesive container 56 along the guide rail 52 from the left side to the right side of FIG. 3B. In the outward path, the applicator roller 57 presses against the sheet bundle to separate the sheet edges. Then, in the return path where it returns from the return position RP to its home position HP, an elevator motor, not shown, adjusts a feed amount of the gripping conveyance means 47 to form a predetermined gap with the sheet edges and to apply adhesive.

### Configuration of Cover-Sheet Binding Means

Cover sheet binding means 60 is disposed in the cover-sheet binding position F of the bookbinding process path 33. The cover sheet binding means 60 is composed of a spine pressing plate 61, a spine folding plate 62, and folding roller 63 as shown in FIG. 4. The cover feed path 34 is disposed in the cover-sheet binding position F, and feeds the cover sheet Sh from either the image-forming unit A or the inserter unit 26. The spine pressing plate 61 is composed of a plate-shaped member to backup and support the cover sheet Sh, and is advancably disposed in the bookbinding process path 33. The inner leaves of the sheet bundle Sn are joined in an upside-down T shape to the cover sheet Sh supported by this spine pressing plate 61 using adhesive. The spine folding plate 62 is composed of a pair of left and right pressing members. In order to fold the spine of the cover sheet joined in an upside-down T-shape, these members are configured to be mutually brought close together and moved apart by a drive means, not shown. The folding rollers 63 are composed of a pair of rollers that nip the sheet bundle formed with a folded spine to finish the booklet.

Note that the present invention folds the spine of the cover sheet while the jacketing sheet Sc is overlaying the cover sheet Sh. The jacketing sheet Sc at this time is arranged at a side touching the spine pressing plate 61, the spine folding plate 62 and the folding roller 63. Therefore, in the folding process, the cover sheet Sh is not soiled or damaged by touching these pressing members.

### Configuration of Sheet-Bundle Attitude Biasing Means

A sheet-bundle attitude biasing means 64 that changes the orientation of the sheet bundle and trimming means 65 that trims edges of the sheet bundle are disposed in the cutting position G downstream of the folding roller 63. The sheet-bundle attitude biasing means 64 turns the sheet bundle covered with sheet from the cover-sheet binding position F to a predetermined direction (orientation) and conveys it to the downstream trimming means 65 or to a storage stacker 67. Also, the trimming means 65 cuts the edges of the sheet bundle to align them. For that reason, the sheet-bundle attitude biasing means 64 is provided rotating tables 64a, 64b that nip the sheet bundle fed from the folding rollers 63 and rotate it. As shown in FIG. 4, the rotating tables 64a and 64b are provided on a unit frame 64x risibly mounted to the apparatus frame. The pair of rotating tables 64a, 64b nip the bookbinding process path 33 and are rotatably supported on the unit frame. On movable rotating table 64b is supported to move in a sheet bundle thickness direction (in a direction perpendicular to the bookbinding process path 33). Revolving motors Mt1, Mt2 are installed on each rotating table 64a, 64b to change the orientation of the sheet bundle in the bookbinding process path 33. A gripping motor Mg that moves in the left and right directions of FIG. 4 is installed in the rotating table 64b of the movable side.

### Configuration of Trimming Means

Trimming means 65 is disposed downstream of the sheet-bundle attitude biasing means 64. As shown in FIG. 4, the trimming means 65 is composed of a trimming edge pressing member 65b that pressingly supports a trimming edge of the sheet bundle against the blade bearing member 65a and a trimming blade unit 65c. The trimming edge pressing unit member 65b is disposed in a position opposing the blade bearing member 65a disposed in the bookbinding process path 33, and is composed of a pressing member that moves in a direction perpendicular by drive means, not shown, to the sheet bundle. The trimming blade unit 65c is composed of a flat, blade-shaped cutting blade 65x and a cutter motor Mc that drives the blade. With the trimming means 65 of this configuration, predetermined amounts of the edges of the sheet bundle, excluding the spine portion, are cut to finish the booklet.

Discharge roller (discharge means) 66 and a storage stacker 67 are provided downstream of the cutting position G. As shown in FIG. 2, the storage stacker 67 stores the sheet bundle in an upright posture. As shown in FIG. 1, the storage stacker 67 is drawably disposed in the casing 30 and can be drawn to the front side of the apparatus (the front side of the sheet of FIG. 1). The user can view from the top direction when it is drawn out to the front side of the apparatus. 67Sf denotes a full detection sensor. This detects when the sheet bundles stored in the storage stacker have reached a full state and issues a warning to remove them to the operator.

Note that the present invention trims the sheet bundle when cutting the sheet bundle as described above with the jacketing sheet Sc covering the cover sheet Sh. Therefore, the cover sheet Sh is neither soiled or damaged by directly touching the rotating tables 64a, 64b, and cutting edge pressing means in the cutting process.

### Configuration of Finishing Unit

A finishing unit C is disposed in the bookbinding unit B; a finishing path 38 connected to the cover feed path 34 is provided in the finishing unit C; a finishing device such as a stapler, punching unit or stamping unit is disposed in the finishing path 38. A printed sheet conveyed out of the image-forming unit A is received via the cover feed path 34, is stapled, punched with a hole or marked, then discharged to the discharge tray 37. Also, sheets conveyed from the image-forming unit without undergoing any finishing process are stored in the discharge tray 37.

### Configuration of Control Means

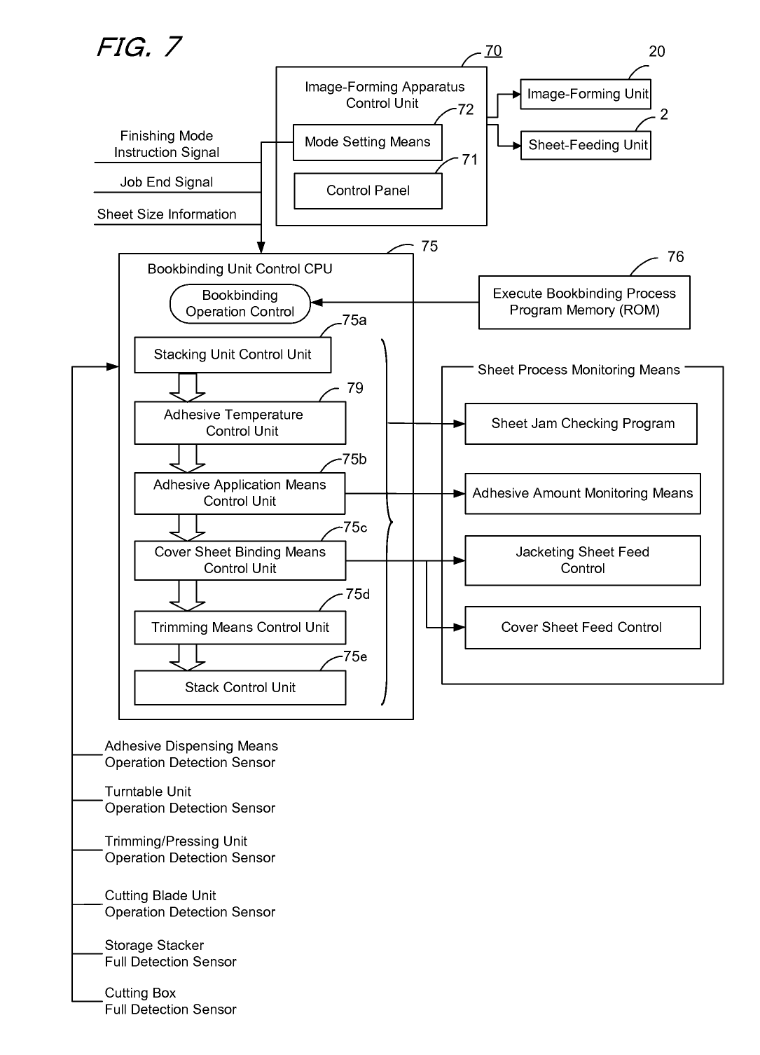

The configuration of the control means in the apparatus described above will be now explained with reference to FIG. 7. FIG. 7 shows a control block diagram. In a system linking the image-forming unit A and bookbinding unit B as shown in FIG. 1, a control panel 71 and mode setting means 72 are provided in the control CPU 70 installed in the image-forming unit A. Also, the control CPU 75 is provided in the control unit of the bookbinding unit B. The control CPU 75 reads a bookbinding process execution program from ROM 76 and executes each process in the bookbinding process path 33.

The control CPU 75 receives from the control CPU 70 in the image-forming unit A a finishing mode instruction signal, job end signal, sheet size information, and other information and command signals required in bookbinding. On the other hand, sheet sensors Se1 to Se6 are disposed in the positions shown in the drawing in the conveyance path 31, bookbinding process path 33 and the cover feed path 34 to detect conveying sheets (sheet bundle). The control CPU 75 is transmitted the detection signals from the sheet sensors Se1 to Se6. The control CPU 75 is provided a stacker control unit 75a, an adhesive application means control unit 75b, a cover sheet binding control unit 75c, a trimming means control unit 75d, a stacker control unit 75e, and an adhesive temperature control unit 79.

It is to be noted that the present application claims priority rights from Japanese Pat. App. No. 2007-182603, which is herein incorporated by reference.

What is claimed is:

1. A bookbinding unit comprising:
stacking tray means for stacking into bundles, and supporting, sheets onto which images have been formed;
a bookbinding process path for guiding sheet bundles from said stacking tray means to a predetermined cover-binding position;
a cover feed path for feeding cover sheets to the cover-binding position;
a protective-sheet storage tray for supplying jacketing sheets to said cover feed path; wherein
a conveyance means for overlaying fed cover sheets with jacketing sheets supplied from said protective-sheet storage tray, and transporting the jacketed cover sheets to the cover-binding position, is disposed in said cover feed path.

2. The bookbinding unit according to claim 1, wherein:
said protective-sheet storage tray is disposed in a sheet-feeding unit that supplies cover sheets to said cover feed path; and
cover sheets are supplied to said cover feed path selectively from the sheet-feeding unit or from an image-forming apparatus.

3. The bookbinding unit according to claim 2, said protective-sheet storage tray being disposed in the sheet-feeding unit for supplying cover sheets to said cover feed path; wherein
the sheet-feeding unit is provided both with a first tray member for storing cover sheets, and a second tray member for storing jacketing sheets.

4. The bookbinding unit according to claim 1, wherein:
said conveyance means disposed in said cover feed path therein has a registration means for momentarily pausing jacketing sheets from said protective-sheet storage tray and overlaying them with the cover sheets; and
said registration means is configured to underlay the jacketing sheets along the spine-cover side of the cover sheets.

5. The bookbinding unit according to claim 2, wherein:
said conveyance means disposed in said cover feed path therein has a registration means for momentarily pausing jacketing sheets from said protective-sheet storage tray and overlaying them with the cover sheets; and
said registration means is configured to underlay the jacketing sheets along the spine-cover side of the cover sheet.

6. The bookbinding unit according to claim 3, wherein:
said conveyance means disposed in said cover feed path therein has a registration means for momentarily pausing jacketing sheets from said protective-sheet storage tray and overlaying them with the cover sheets; and
said registration means is configured to underlay the jacketing sheets along the spine-cover side of the cover sheet.

7. The bookbinding unit according to claim 1, wherein:
a trimming means is disposed along said bookbinding process path, downstream of the cover-binding position;
a stacking means for stacking booklet-formation sheets from the trimming means is disposed in said bookbinding process path;
said trimming means is configured to trim the jacketing sheets at the same time it trims true the edges of cover-binding processed sheet bundles; and
said stacking means is configured to store the sheet bundles and jacketing sheets having been trimmed true by said trimming means.

8. The bookbinding unit according to claim 2, wherein:
a trimming means is disposed along said bookbinding process path, downstream of the cover-binding position;
a stacking means for stacking booklet-formation sheets from the trimming means is disposed in said bookbinding process path;
said trimming means is configured to trim the jacketing sheets at the same time it trims true the edges of cover-binding processed sheet bundles; and
said stacking means is configured to store the sheet bundles and jacketing sheets having been trimmed true by said trimming means.

9. The bookbinding unit according to claim 3, wherein:
a trimming means is disposed along said bookbinding process path, downstream of the cover-binding position;
a stacking means for stacking booklet-formation sheets from the trimming means is disposed in said bookbinding process path;
said trimming means is configured to trim the jacketing sheets at the same time it trims true the edges of cover-binding processed sheet bundles; and
said stacking means is configured to store the sheet bundles and jacketing sheets having been trimmed true by said trimming means.

10. The bookbinding unit according to claim 4, wherein:
a trimming means is disposed along said bookbinding process path, downstream of the cover-binding position;
a stacking means for stacking booklet-formation sheets from the trimming means is disposed in said bookbinding process path;
said trimming means is configured to trim the jacketing sheets at the same time it trims true the edges of cover-binding processed sheet bundles; and
said stacking means is configured to store the sheet bundles and jacketing sheets having been trimmed true by said trimming means.

11. An image forming system comprising:
an imaging unit for sequentially forming predetermined images onto sheets; and
a bookbinding unit, linked to a discharge outlet of said imaging unit, for collating into bundles sheets into which images have been formed, and binding the bundles together with cover sheets; wherein
said bookbinding unit is configured as set forth in claim 1.

12. An image forming system comprising:
an imaging unit for sequentially forming predetermined images onto sheets; and
a bookbinding unit, linked to a discharge outlet of said imaging unit, for collating into bundles sheets into which images have been formed, and binding the bundles together with cover sheets; wherein
said bookbinding unit is configured as set forth in claim 2.

13. An image forming system comprising:
an imaging unit for sequentially forming predetermined images onto sheets; and
a bookbinding unit, linked to a discharge outlet of said imaging unit, for collating into bundles sheets into which images have been formed, and binding the bundles together with cover sheets; wherein
said bookbinding unit is configured as set forth in claim 3.

14. An image forming system comprising:
an imaging unit for sequentially forming predetermined images onto sheets; and
a bookbinding unit, linked to a discharge outlet of said imaging unit, for collating into bundles sheets into which images have been formed, and binding the bundles together with cover sheets; wherein
said bookbinding unit is configured as set forth in claim 4.

15. An image forming system comprising:
an imaging unit for sequentially forming predetermined images onto sheets; and
a bookbinding unit, linked to a discharge outlet of said imaging unit, for collating into bundles sheets into which images have been formed, and binding the bundles together with cover sheets; wherein
said bookbinding unit is configured as set forth in claim 7.
